(19) United States
(12) Patent Application Publication
(10) Pub. No.: US 2005/0096793 A1
(43) Pub. Date: May 5, 2005

(54) Reference model tracking control system and method

(75) Inventor: Kenji Takeuchi, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/976,366

(22) Filed: Oct. 29, 2004

(30) Foreign Application Priority Data
Oct. 30, 2003 (JP) 2003-371095

(51) Int. Cl. G06F 19/00

(52) U.S. Cl. 700/245

(57) ABSTRACT

A control system makes the state variable of a controlled object track that of a reference model. A disturbance observer estimates disturbance added to the control input, and the internal state variable of the object at a predetermined sampling cycle, based on the control input and observed output of the object. The observer outputs the estimated disturbance and internal state variable as disturbance and state variable estimates. A reference model tracking controller generates a control input of the object at the next sampling cycle, based on a linear control input, disturbance estimate and nonlinear control input. The linear control input is generated by a linear controller to converge an error in the state variable estimate and observed output of the object with respect to the reference state variable. The nonlinear control input is an error in the disturbance estimate with respect to disturbance actually added to the control input.

### CROSS-REFERENCE TO RELATED APPLICATIONS

This application is based upon and claims the benefit of priority from prior Japanese Patent Application No. 2003-371095, filed Oct. 30, 2003, the entire contents of which are incorporated herein by reference.

### BACKGROUND OF THE INVENTION

1. Field of the Invention

The present invention relates to a reference model tracking control system and method suitable for causing the internal state variable of a controlled object to track a reference state variable as the internal state variable of a reference model, the relationship between the control input and observed output of the controlled object being modeled by a state equation.

2. Description of the Related Art

As a guideline for designing a control system, designing a control system (control system of a so-called high robustness) is exemplified, which provides excellent performance regardless of changes in environment or unpredictable events such as disturbance. For instance, recent magnetic disk drives have come to be used not only as additional storage for personal computers, but also in various apparatuses, such as home electronic equipment, car navigation systems, and mobile audio apparatuses. In accordance with the divergent uses of magnetic disk drives, there is an increasing demand for a highly robust control system for use in the drives. Specifically, what is required is a seeking technique for moving a magnetic head to a desired position on a magnetic disk with low noise and high speed, regardless of disturbances, under demanding conditions of use. Environments of strict conditions of use include, for example, the existence of disturbance, and changes in various parameters (for instance, electrical resistance, moment of inertia, and temperature) that cause errors in modeling a voice coil motor (VCM).

To satisfy this requirement, various seeking techniques used in magnetic disk drives have been contrived, as will now be described. Firstly, magnetic disk drives are known as electromechanical systems that can be relatively easily modeled. This is because, in magnetic disk drives, disturbance and modeling errors are collectively considered as disturbance, thereby allowing a robust servo system based on the estimation of disturbance to be constructed. Use of a disturbance observer, for example, is known as a method for estimating disturbance. The disturbance observer estimates the state variable of a controlled object, and a disturbance to be added to a control input to be supplied to the object, using the output information and control input information of the controlled object. Further, a reference model adaptive nonlinear control method (a so-called reference model adaptive sliding mode control method) is also known. In the reference model adaptive sliding mode control method, the state of a controlled object is made to track the state trajectory of a mathematical model of the controlled object in a system free of disturbance, thereby suppressing the influence of disturbance. Jpn. Pat. Appln. KOKAI Publication No. 2002-287804 (prior art document) has proposed a technique, for use in a refrigerating or air-conditioning system, in which the disturbance observer method and reference model adaptive sliding mode control method are combined.

In the prior art document, the combination of the disturbance observer method and reference model adaptive sliding mode control method enables the amplitude of the nonlinear input of the sliding mode control to be kept low, thereby reducing the degree of chattering. However, this is realized on the assumption that the disturbance observer can accurately estimate the state variable and disturbance. Actually, however, in a system in which the noise component of an observed output (measured output) (i.e., observation noise) is high, or a large modeling error occurs, or parameters vary significantly, the state estimate and disturbance estimate do not always converge on respective correct values. In other words, in many cases, the state variable and disturbance are not accurately estimated by the disturbance observer. Accordingly, in actual systems, the nonlinear input gain of sliding mode control cannot be kept low and chattering may not be sufficiently reduced.

In sliding mode control, the mode used is roughly divided into two modes, one (reaching mode or reaching phase) which is assumed until the state of a controlled object reaches a switching plane on which the state shows an ideal state trajectory, and the other mode (sliding mode) which keeps the state on the switching plane. It is known that robustness in the face of disturbance is secured when the state of the system is being controlled in sliding mode. If the initial estimate of the disturbance observer greatly differs from an actual value, an initial response occurs in the state estimation of the observer. In this case, the state variable or disturbance cannot accurately be estimated. If a significant initial disturbance is applied to the controlled object, robustness may not be secured because of the influence of the initial responses of the disturbance observer and the reaching phase of sliding mode control.

### BRIEF SUMMARY OF THE INVENTION

In accordance with an embodiment of the invention, there is provided a reference model tracking control system for determining a control input supplied to a controlled object based on an observed output of the controlled object and a reference value. The relationship between the control input and the observed output of the controlled object is modeled using a state equation. The reference value is a desired value of the observed output. The reference model tracking control system comprises a disturbance observer, reference model, error calculator, linear controller and reference model tracking controller. The disturbance observer is configured to estimate a disturbance added to the control input, and an internal state variable of the controlled object at a predetermined sampling cycle, based on the control input and the observed output of the controlled object. The disturbance and the internal state variable estimated by the disturbance observer are output as a disturbance estimate and a state variable estimate, respectively. The reference model is a simplified ideal model of the controlled object. The reference model is configured to cause a reference output corresponding to the observed output of the controlled object to track the reference value. The reference model outputs, as a reference state variable, the internal state variable of the reference model acquired during tracking of the reference value. The error calculator is configured to calculate an error in the state variable estimate and the observed output of the controlled object with respect to the reference state variable. The linear controller is configured to generate a linear control input for converging the error calculated by the error calculator. The reference model tracking controller is configured to generate another control input supplied to the controlled object at a next sampling cycle, based on the linear control input, the disturbance estimate and a nonlinear control input. The nonlinear control input is an error in the disturbance estimate with respect to a disturbance actually added to the control input at a present sampling cycle.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of a reference model tracking control system according to an embodiment of the invention;

FIG. 2 is a graph illustrating a relationship example between error eₘ and desired velocity xᵣ held in the velocity table 122 appearing in FIG. 1;

FIGS. 3A and 3B are Bode diagrams of the controlled object 2 appearing in FIG. 1;

FIGS. 4A and 4B are Bode diagrams of the reference model 121 appearing in FIG. 1;

FIG. 5 is a graph illustrating changes with time in the position (xₘ₁) of the reference model 121;

FIG. 6 is a graph illustrating changes with time in the velocity (xₘ₂) of the reference model 121;

FIG. 7 is a graph illustrating changes with time in the position (x₁) of the controlled object 2;

FIG. 8 is a graph illustrating changes with time in the velocity (x₂) of the controlled object 2;

FIG. 9 is a graph illustrating changes with time in the level of control input uₘ supplied to the reference model 121;

FIG. 10 is a graph illustrating changes with time in the level of control input u supplied to the controlled object 2;

FIG. 11 is a graph illustrating changes with time in the level of nonlinear input u_{d}′ acquired by filtering the output of the sliding mode controller 151 appearing in FIG. 1 by the nonlinear input lowpass filter 152 appearing in FIG. 1;

FIG. 12 is a graph illustrating changes with time in the level of disturbance d′ actually exerted on the controlled object 2, and changes with time in disturbance estimate \hat{d}′ acquired by the disturbance observer 11 appearing in FIG. 1; and

FIG. 13 is a graph illustrating changes with time in the level of disturbance d′ exerted on the controlled object 2, and changes with time in the sum (actual disturbance estimate \hat{d}′+u_{d}′) of disturbance estimate \hat{d}′ acquired by the disturbance observer 11 and disturbance estimate u_{d}′ acquired by the reference model tracking controller 15 appearing in FIG. 1.

### DETAILED DESCRIPTION OF THE INVENTION

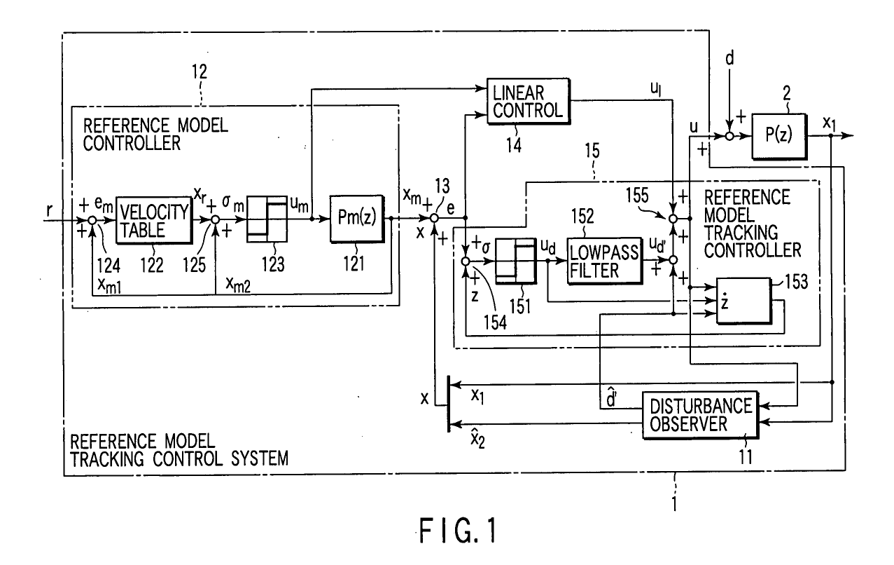

An embodiment of the invention will be described in detail with reference to the accompanying drawings. FIG. 1 is a block diagram illustrating the configuration of a reference model tracking control system 1 according to an embodiment of the invention. The control system 1 is supposed to be used in a magnetic disk drive using a disk (magnetic disk) as a recording medium. In the magnetic disk drive, seek control is performed in which a head (magnetic head) for reading/writing data is moved to a desired position (desired track) on the disk. The head is radially moved over the disk by driving an actuator that supports it. The actuator is driven by a voice coil motor (VCM).

A controlled object 2 controlled by the reference model tracking control system 1 is the actuator including the voice coil motor in the magnetic disk drive. In this case, the relationship between the control input u of the controlled object 2 and the observed output x₁ of the controlled object 2 is modeled using a state equation. The observed output x₁ is position information indicating the position on the disk of the head supported by the actuator, i.e., head position. An external disturbance d is applied to the input terminal of the controlled object and added to the control input u. Further, a modeling error exists as a disturbance in the controlled object 2. The external disturbance d and modeling error will hereinafter collectively be referred to as “the disturbance d′” on the controlled object 2.

The control system 1 comprises a disturbance observer 11, reference model controller 12, error calculator 13, linear controller 14 and reference model tracking controller 15. The disturbance observer 11 acquires the control input u and observed output x₁ of the controlled object 2 at a preset sampling cycle, and estimates the disturbance d′ on the controlled object 2 and the state variable x₂ (state variable) of the object 2, based on the control input u and observed output x₁. The state variable x₂ is the state variable of the controlled object 2 other than the observer output x₁. For example, the state variable x₂ is the movement velocity of the head (head velocity). The estimates of the disturbance d′ and state variable x₂ are represented by \hat{d}′ and \hat{x}₂, respectively. Further, the observed output x₁ of the object 2 and state variable estimate \hat{x}₂ will collectively be referred to as “state variable x”.

The reference model tracking controller 12 includes a reference model 121 as a simplified formula model of the controlled object 2. Unlike the controlled object 2, the reference model 121 is an ideal model with no disturbance, parameter variation or observation noise. In this embodiment, a simplified model, in which a primary component (head position) and a secondary component (head velocity) are modeled, is used as the reference model 121. The reference model controller 12 is constructed to cause the observed output (reference output) xₘ₁ of the reference model 121 to track a target reference value (reference input) r without errors, and to cause the state variables (reference state variables) xₘ₁ and xₘ₂ of the reference model 121 to exhibit desired transient characteristics. The reference value r indicates the desired position of the head. The state variables xₘ₁ and xₘ₂ indicate the head position and head velocity, respectively. The state variables xₘ₁ and xₘ₂ are collectively represented by the state variable xₘ. In the embodiment, to realize the reference model controller 12, a velocity table and sliding mode control are employed. Velocity tables are often used for seek control in magnetic disk drives. Sliding mode control enables a desired velocity, even if a desired velocity that causes an abrupt velocity change is given from the velocity table, to be quickly tracked without errors.

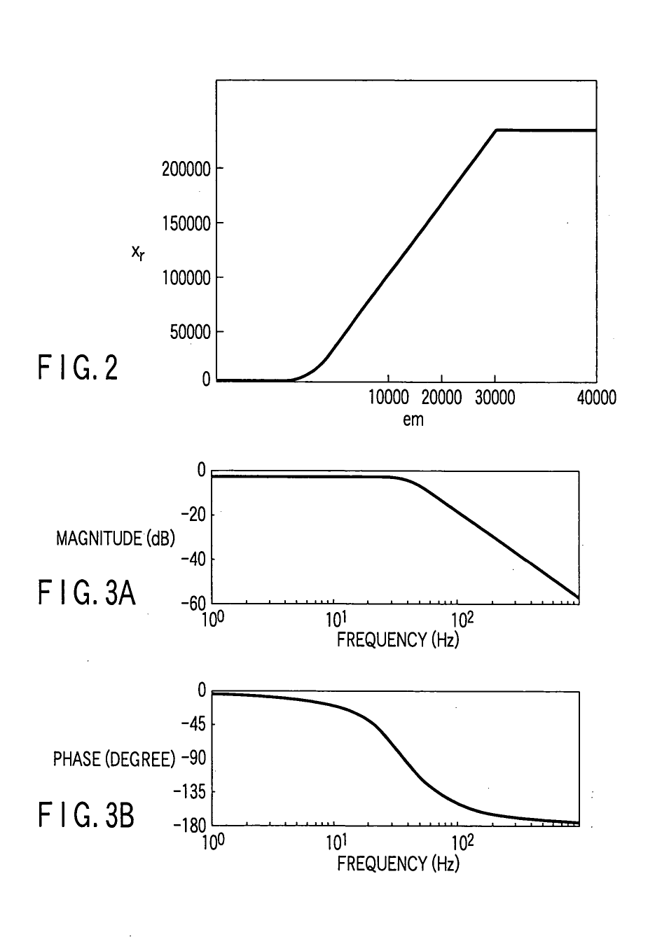

In light of this, the reference model controller 12 comprises, as well as the reference model 121, a velocity table 122, sliding mode controller 123 and error calculators 124 and 125. The error calculator 124 calculates the error eₘ in the state variable xₘ₁ with respect to the reference value r, and the velocity table 122 holds a desired velocity corresponding to each preset error in head position. The velocity table 122 is used to determine (set) a desired velocity xᵣ corresponding to the error eₘ calculated by the error calculator 124. FIG. 2 shows a relationship example between error eₘ and desired velocity xᵣ held in the velocity table 122. In this example, the desired velocity xᵣ is set to a value proportional to the error em until the error eₘ reaches a preset value. When the error eₘ exceeds the preset value, the desired velocity xᵣ is kept at a certain value regardless of the error eₘ. In the example of FIG. 2, the desired velocity xᵣ is represented by the quantity of movement (head movement quantity, e.g., the number of cylinders) of the reference model 121 per unit time (e.g., per second). On the other hand, the error eₘ is represented by the quantity of movement (e.g., the number of cylinders) of the reference model 121 from the present position (head position) indicated by the state variable xₘ₁ to a desired position indicated by the reference value r.

The error calculator 124 calculates the error σₘ in the state variable xₘ₂ with respect to the desired velocity xᵣ determined from the velocity table 122. The sliding mode controller 123 generates (calculates), using the error σₘ as a switching function, a nonlinear control input uₘ supplied to the reference model 121, which makes the error σₘ zero. As described above, the reference model 121 is an ideal model free from disturbance, observation noise, etc., therefore sliding mode control by the sliding mode controller 123 is easy to apply to it. Further, even if a desired velocity that causes an abrupt velocity change is given from the velocity table 122, sliding mode control enables the reference model controller 123 to realize a higher tracking performance with less chattering, compared to the case of using linear control.

The error calculator 13 compares the state variable xₘ (xₘ₁, xₘ₂) output from the reference model 121 in the reference model controller 12, with the state variable x (x₁, \hat{x}₂) of the controlled object 2, thereby calculating its deviation (tracking error) e. As stated above, the state variables x₁, \hat{x}₂ that provide the state variable x of the controlled object 2 are state estimates acquired from the observed output of the controlled object 2 and the disturbance observer 11. The error e includes the error (deviation) e₁ in the state variable xₘ₁ with respect to the observed output x₁, and the error (deviation) e₂ in the state variable xₘ₂ with respect to the state variable estimate \hat{x}₂. The control system 1 is constructed to cause the state variable x (x₁, \hat{x}₂) of the controlled object 2 to track the state variable xₘ(xₘ₁, xₘ₂) of the reference model 121 without errors, i.e., to make zero the error e.

To this end, the linear controller 14 in the control system 1 is designed to secure the convergence of the error e in an ideal state in which no disturbance exists in the controlled object 2. Specifically, the linear controller 14 is designed to output (calculate) a linear control input u₁ in accordance with the control input uₘ supplied to the reference model 121 and the error e. On the other hand, the reference model tracking controller 15 is constructed to acquire the linear control input u₁ and disturbance estimate \hat{d}′ at the above-mentioned sampling cycle. The reference model tracking controller 15 is also designed to generate a control input to be supplied to the controlled object 2 at the next sampling cycle, based on the linear control input u₁, disturbance estimate \hat{d}′ and nonlinear control input u_{d}. The nonlinear control input u_{d} is the error in the disturbance estimate \hat{d}′ with respect to the disturbance d actually added to the control input u of the controlled object 2. The reference model tracking controller 15 comprises a lowpass filter 152, integral dynamics 153 and adders 154 and 155, as well as a sliding mode controller 151 as described in the previously mentioned prior art document. The adder 154 calculates the sum σ of the error e and a variable z acquired from the integral dynamics 153. The adder 155 calculates, as the control input u of the controlled object 2, the sum of the output (liner control input) u₁ of the linear controller 14, the output (nonlinear control input) u_{d}′ of the lowpass filter 152, and the disturbance estimate \hat{d}′ acquired (calculated) by the disturbance observer 11. The sign of the liner control input u₁ is opposite to that of the nonlinear control input u_{d}′ and disturbance estimate \hat{d}′. This means that, in the embodiment, u_{d}′ and \hat{d}′ are beforehand subtracted from the control input.

As described above, in the embodiment, the control input supplied to the controlled object 2 at the next sampling cycle is generated, using not only the linear control input u₁ but also the disturbance estimate (input) \hat{d}′ as an input for offsetting disturbance, and the nonlinear control input u_{d}′ as the estimate (disturbance estimate error) of a disturbance component that cannot be offset by the disturbance estimate. As a result, even if the controlled object 2 contains modeling inaccuracy, disturbance, etc., good control performance can be achieved as in a system free from disturbance.

The sliding mode controller 151 uses, as a switching function, the sum σ of the error e and the variable z acquired from the integral dynamics 153, thereby generating (calculating) a nonlinear input (nonlinear control input) u_{d} that makes the sum σ zero. The lowpass filter 152 eliminates a high-frequency component from the nonlinear input u_{d}. The nonlinear input u_{d} from which a high-frequency component is eliminated is represented by u_{d}′. In sliding mode control by the sliding mode controller 151, it is generally necessary to observe all states (state variables) of the controlled object 2. Actually, however, it is impossible to do so because of problems concerning, for example, sensors. Therefore, as described in the prior art document, the sliding mode controller 151 is combined with the disturbance observer 11 to utilize the disturbance estimate \hat{d}′ and state variable estimate \hat{x}₂ acquired from the disturbance observer 11.

However, in a system in which the level of noise of the observed output is high and/or a large modeling error occurs, the disturbance observer 11 often cannot accurately estimate a disturbance component or state variable. In the embodiment, to realize more accurate estimation of a disturbance component than in the case of using the disturbance observer 11, the reference model tracking controller 15 performs integral sliding mode control on a switching plane. The integral sliding mode control includes the integral dynamics 153. In other words, the reference model tracking controller 15 is an integral sliding mode controller. Further, in the embodiment, a combination of the estimate u_{d} (u_{d}′) acquired by integral sliding mode control and the disturbance estimate \hat{d}′ acquired by the disturbance observer 11 is used. This combination enables the reference model tracking controller 15 to have a structure that considers only the error in the disturbance estimate acquired by the disturbance observer 11 with respect to an actual disturbance value. This structure can suppress the amplitude of a nonlinear gain, compared to the case of using only the disturbance observer 11. Furthermore, in the embodiment, only the nonlinear input u_{d}, included in the control inputs supplied to the controlled object 2 in the prior art and generated by the sliding mode controller 151, is input to the controlled object 2 via the lowpass filter 152. As a result, chattering can be suppressed without significantly reducing the robustness of the sliding mode in the whole system. Further, integral sliding mode control by the reference model tracking controller 15 enables robust control even in an initial response in which no reaching phase exists.

A description will now be given of details of the reference model tracking control system shown in FIG. 1. That is, the reference model controller 12, disturbance observer 11 and reference model tracking controller 15 will be mainly described in this order.

[Reference Model Controller 12]

Assume here that the controlled object 2 is expressed by the following equation:

$$P ( z ) : \{ \begin{matrix}\dot{x} = Ax + Bu + Bd \\ y = Cx \end{matrix} \qquad ( 1 )$$

where A, B and C represent coefficient matrixes concerning “state”, “input” and “output”, respectively, i.e., a state matrix, input matrix and output matrix, respectively. Further, u and y represent a control input and observed output, respectively. d represents an external disturbance applied to the input terminal of the controlled object 2 with the same measurement range as the control input (i.e., added to the control input u), and x represents an internal state variable (in this embodiment, the head position). \dot{x} (i.e., x with mark “\dot{}”) represents the differential value of x (in this embodiment, the head velocity). u and d have opposite signs.

The reference model 121 is expressed by the following equation:
Pₘ(z): \dot{x}ₘ=Aₘxₘ+Buₘ (2)

As described above, the reference model 121 is a model obtained by simplifying the controlled object 2. Assume that a modeling error exists between the coefficient matrixes A and Aₘ. In this case, it is considered that the controlled object 2 corresponding to the reference model 121 has both the external disturbance d and modeling error (Aₘ−A)x. If the modeling error (Aₘ−A)x is input with the same measuring range as the input matrix B, the external disturbance d and modeling error (Aₘ−A)x can be collectively regarded as the disturbance d′ on the controlled object 2. Accordingly, equation 1 can be replaced with the following equation 3:

$$P ( z ) : \{ \begin{matrix}\dot{x} = {A}_{m} x + Bu + {Bd}^{′} & ( {Bd}^{′} = Bd + ( A - {A}_{m} ) x ) \\ & y = Cx\end{matrix} \qquad ( 3 )$$

The reference model controller 12 including the reference model 121 expressed by equation 2 has a controller for controlling the reference model 121 to cause the state variable xₘ₁ of the reference model 121 to track the reference value (reference input) r without errors. To design this controller, it would be advisable to consider a transient response such as overshooting. In this embodiment, for facility of designing and enhancement of performance of tracking the reference value r, the sliding mode controller 123 utilizing the velocity table 122 is employed.

Assume that the value (desired velocity) in the velocity table 122 corresponding to the error eₘ is represented by xᵣ. As stated above, the error eₘ is the error in the state variable (head position) xₘ₁ of the reference model 121 with respect to the reference value (desired position) r. From the error σₘ between xᵣ and the state variable (head velocity) xₘ₂ of the reference model 121, the switching function of the sliding mode controller 123 is given by
σₘ=xᵣ−xₘ₂ (4)

Further, the nonlinear input uₘ based on the existing conditions of the sliding mode is used as the control input of the reference model 121. In this embodiment, the sliding mode controller 123 is constructed so that the nonlinear input uₘ, given by the following equation 5, is generated in accordance with the error σₘ:

$${u}_{m} = - q \frac{{σ}_{m}}{\vert {σ}_{m} \vert + α} \qquad ( 5 )$$

where q represents a nonlinear input gain, and α a smoothing ratio. If α is high, the nonlinear input uₘ is more smoothed to reduce the degree of chattering. However, if α is high, the robustness of the sliding mode is lost. Accordingly, α is determined from a tradeoff between the required smoothness and robustness. As is evident from equation 5, in the embodiment, a smoothing function is used, instead of a relay function, as a function for determining the nonlinear input uₘ by the sliding mode controller 123, thereby preventing the reference state variable xₘ of the reference model 121 from chattering.
[Disturbance Observer 11]

A description will then be given of the disturbance observer 11. As described above, it is necessary to observe the whole state of the controlled object 2 during sliding mode control. Actually, however, it is difficult to do so. Therefore, an observer for estimating the state is used. In the embodiment, the function of the observer is extended to estimate a disturbance of the controlled object 2. Specifically, the disturbance observer 11 employed in the embodiment has a function for estimating a disturbance of the controlled object 2 and the state variable of the object 2. In the embodiment, an augmented system is presupposed in which the disturbance d′ is treated as one of the state variables of the controlled object 2. Assume first that the disturbance d′ satisfies the following equation 6:
\dot{d}′=0 (6)

In this case, the equation of state used in the augmented system is expressed in the following manner:

$$\{ \begin{matrix}[ \begin{matrix}\dot{x} \\ {\dot{d}}^{′}\end{matrix} ] = [ \begin{matrix}{A}_{m} & B \\ 0 & 0\end{matrix} ] [ \begin{matrix}x \\ {d}^{′}\end{matrix} ] + [ \begin{matrix}B \\ 0\end{matrix} ] u \\ y = [ \begin{matrix} & \\ C & 0 \\ & \end{matrix} ] [ \begin{matrix}x \\ {d}^{′}\end{matrix} ] \end{matrix} \qquad ( 7 )$$

The state estimation function of the disturbance observer 11 that matches the augmented system is given by

$$\{ \begin{matrix}[ \begin{matrix}\dot{x} \\ {\dot{\hat{d}}}^{′}\end{matrix} ] = [ \begin{matrix}{A}_{m} & B \\ 0 & 0\end{matrix} ] [ \begin{matrix}\hat{x} \\ {\hat{d}}^{′}\end{matrix} ] + [ \begin{matrix}B \\ 0\end{matrix} ] u + [ \begin{matrix}{l}_{1} \\ {l}_{2}\end{matrix} ] ( y - \hat{y} ) \\ \hat{y} = [ \begin{matrix} & \\ C & 0 \\ & \end{matrix} ] [ \begin{matrix}\hat{x} \\ {\hat{d}}^{′}\end{matrix} ] \end{matrix} \qquad ( 8 )$$

where l₁ and l₂ represent the gains (observer gains) of the disturbance observer 11. Appropriate observer gains l₁ and l₂ should be selected in consideration of the observation noise, modeling error, etc., so that the error in the state estimate acquired (calculated) by the disturbance observer 11 with respect to an actual value will be stabilized. However, the state estimate acquired by the disturbance observer 11 does not promptly converge to the actual value simply by selecting appropriate observer gains l₁ and l₂. To solve this problem, the reference model tracking controller 15 described below in detail is employed.

[Reference Model Tracking Controller 15]

The reference model tracking controller 15 is constructed to cause the state variable x of the controlled object 2 to track the state variable xₘ of the reference model 121 without errors. In this embodiment, the sum of the linear input u₁, the nonlinear input u_{d}, and the disturbance estimate \hat{d}′ acquired by the disturbance observer 11 is used as the control input u of the controlled object 2. Actually, however, the nonlinear input u_{d}′ acquired by filtering the nonlinear input u_{d} by the lowpass filter 152 is used instead of the nonlinear input u_{d}. This is to eliminate chattering due to the nonlinear input u_{d} from the main loop of the control system 1. Accordingly, the control input u of the controlled object 2 is given by
u=u₁+u_{d}′+\hat{d}′ (9)

The linear input u₁ is used to control the overall behavior of the system, while the nonlinear input u_{d}′ is used to eliminate a disturbance or eliminate inaccuracy from modeling error.

The linear input u₁ is generated by the liner controller 14 in accordance with the error e calculated by the error calculator 13, and the control input uₘ supplied to the reference model 121. The error e is the error in the state variable x of the controlled object 2 with respect to the state variable xₘ of the reference model 121. The generation of the linear input u₁ by the linear controller 14 is performed using linear-state feedback control, the feedforward input of the reference model 121, and the following equation 10:
uₗ=B^{T}(\dot{x}ₘ−Aₘ×+Ke)=B^{T}((Aₘ+K)e+Buₘ) (10)
where K represents a proportional gain that secures the convergence of the error e.

The nonlinear input u_{d} is generated by the sliding mode controller 151. The sliding mode controller 151 performs sliding mode control to reduce the influence of a disturbance. The sliding mode controller 151 is used as a disturbance estimator. A switching function a used by the sliding mode controller 151 is given by the following equation that uses the error e and integral dynamics z:
σ=e+z (11)

Further, the nonlinear input u_{d} generated by the sliding mode controller 151 is given by
u_{d}=Msign(σ) (12)
where M represents a nonlinear gain. In this case, it is sufficient if the integral dynamics z satisfies the following equation 13. However, it is presupposed that both the switching function a and the differential value of the switching function σ should be set to zero. In other words, the integral dynamics z represents a value whose absolute value is identical to that of the error e used in equation 11, but whose sign is opposite to the error e. That is, the integral dynamics z makes the switching plane zero.

$$\begin{matrix}\dot{z} = - {\dot{x}}_{m} + {A}_{m} x + Bu - {u}_{d} + B {\hat{d}}^{′} \\ = - {A}_{m} e - {Bu}_{m} + Bu - BMsign ( σ ) + B {\hat{d}}^{′}\end{matrix} \qquad ( 13 )$$

Furthermore, as can be understood from the equation 13, the integral dynamics z includes the dynamics (coefficient matrix) Aₘ of the reference model 121. From this, it can be understood that the integral dynamics z serves as a kind of model tracking control. From the above, the differential value of the switching function a is given by
\dot{σ}=\dot{e}+\dot{z}=−Bd′−BMsign(σ)+B\hat{d}′<B|\hat{d}′−d′|−BMsign(σ) (14)

As is evident from equation 14, it is necessary to determine the nonlinear gain M used to generate the nonlinear input u_{d} given by equation 12, in consideration of the error (estimated error) in the disturbance estimate \hat{d}′ acquired by the disturbance observer 11 with respect to the disturbance d′.

The level of the input (nonlinear input) used in the sliding mode controller 151 to actually converge the state of the controlled object 2 to the switching plane is acquired. To this end, V=\hat{σ}²/2 is used as a Lyapunov function candidate. If the Lyapunov function satisfies the following equation 15, the control system 1 is asymtotically stabilized:
\dot{V}=σ\dot{σ}≦0 (15)

If equation 14 is combined with equation 15, the following equation 16 is acquired:
\dot{V}=σ\dot{σ}<|σ|(B|\hat{d}′−d′|)−BM|σ| (16)

Accordingly, to realize the sliding mode, the nonlinear gain M that satisfies the following equation 17 is selected:
M>|\hat{d}′−d′| (17)

As can be understood from equation 17, the amplitude of the nonlinear gain M can be suppressed, compared to the case of using only the disturbance d′, by the use of the disturbance estimate \hat{d}′ acquired by the disturbance observer 11, more specifically, by the use of (\hat{d}′−d′). As a result, chattering in the main loop of the control system 1 can be prevented.

Furthermore, in the equation 13, the initial value of the integral dynamics z is set as given by
z(0)=−e(0) (18)

The above-described control enables the combination of the sliding mode controller 151 and integral dynamics 153 to be used as a sliding mode controller with no reaching phase. As a result, control of high robustness can be realized.

In the embodiment, to determine the nonlinear input u_{d} used to estimate a disturbance, the sliding mode controller 151 is combined with the lowpass filter 152 for preventing chattering. To determine the nonlinear input u_{d}, the relay function as given by equation 12 is not use, but the acceleration reaching rule as given by the following equation 19 is use for preventing chattering. Alternatively, to prevent chattering, the previously mentioned smoothing function (see equation 5) may be utilized, as in the sliding mode controller 123.
u_{d}=M|σ|^{β}sign(σ)0<β<1 (19)

If the control input u_{d} acquired from equation 19 is used, the velocity of convergence of the state variable can be increased when the state of the controlled object 2 is at a long distance from the switching plane. Further, since the velocity of convergence is reduced in the vicinity of the switching plane, the degree of chattering is reduced also from this point.

The advantage of the seek control system in a magnetic disk drive, realized by the reference model tracking control system 1, will now be described using simulations. The controlled object 2 and reference model 121 used in the simulations are expressed by the following equations 20 and 21, respectively:

$$\begin{matrix}P ( z ) : \{ \begin{matrix}\dot{x} = [ \begin{matrix}0 & 1 \\ - 63165 & - 302\end{matrix} ] x + [ \begin{matrix}0 \\ 50000\end{matrix} ] \overline{u} + [ \begin{matrix}0 \\ 50000\end{matrix} ] d \\ \vert \overline{u} \vert < 3500\end{matrix} & ( 20 ) \\ {P}_{m} ( z ) : \{ \begin{matrix}{\dot{x}}_{m} = [ \begin{matrix}0 & 1 \\ 0 & 0\end{matrix} ] {x}_{m} + [ \begin{matrix}0 \\ 50000\end{matrix} ] {\overline{u}}_{m} \\ \vert {\overline{u}}_{m} \vert < 3500\end{matrix} & ( 21 )\end{matrix}$$

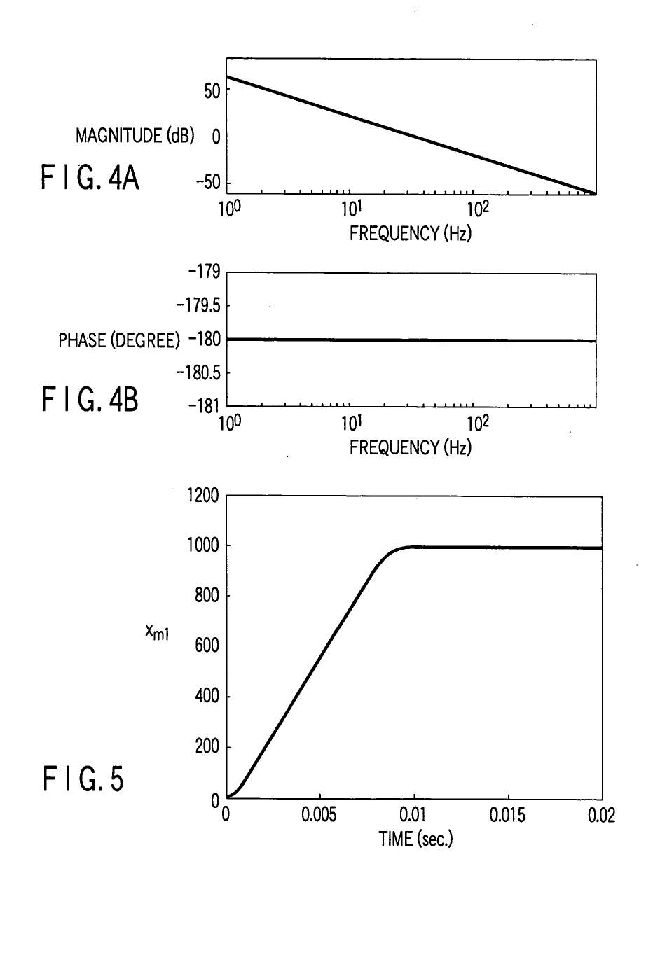

The controlled object 2 expressed by equation 20 is an actuator (head actuator) driven by a voice coil motor employed in the magnetic disk drive. The controlled object 2 is basically defined as the basic second-order lag model shown in the Bode diagrams of FIGS. 3A and 3B. In addition, the object 2 is defined to have the external disturbance d and to have restricted range of inputs. On the other hand, the reference model 121 given by equation 20 is a model formed of simple integrators that comprise a solid mode having the characteristics shown in the Bode diagrams of FIGS. 4A and 4B. This model is employed to facilitate designing of the reference model controller 12 including the reference model 121. The reference model 121 has a limiter function for limiting the range of inputs supplied to the controlled object 2. Thus, the embodiment is directed to the reference model tracking control system 1 in which the model given by equation 20 is used as the controlled object 2, and the reference model 121 given by equation 21 is included. In this case, the cutoff frequency of the disturbance observer 11 is set to, for example, 600 Hz in consideration of, for example, actual observation noise. Further, the sliding mode controller 151 and the lowpass filter 152 are utilized for determining the sliding mode nonlinear input u_{d}. The acceleration reaching rule given by equation 19 is used to suppress the occurrence of chattering. Concerning a case where a disturbance d with a frequency of 100 Hz and an amplitude of 100 is applied, seek control in which the head is moved by 1000 cylinders at a sampling frequency of 10 kHz was simulated.

FIGS. 5, 6, 7 and 8 show results of the simulation, i.e., changes with time in the head position (Xₘ₁) of the reference model 121, in the head velocity (Xₘ₂) of the reference model 121, in the actual head position (X₁) of the controlled object 2, and in the actual head velocity (X₂) of the controlled object 2, respectively. Further, FIGS. 9, 10 and 11 show changes with time in the level of the control input (uₘ) of the reference model 121, in the level of the actual control input (u) of the controlled object 2, and in the level of nonlinear input acquired (calculated) by the sliding mode controller 151 (i.e., the nonlinear input u_{d}′ acquired through the lowpass filter 152), respectively.

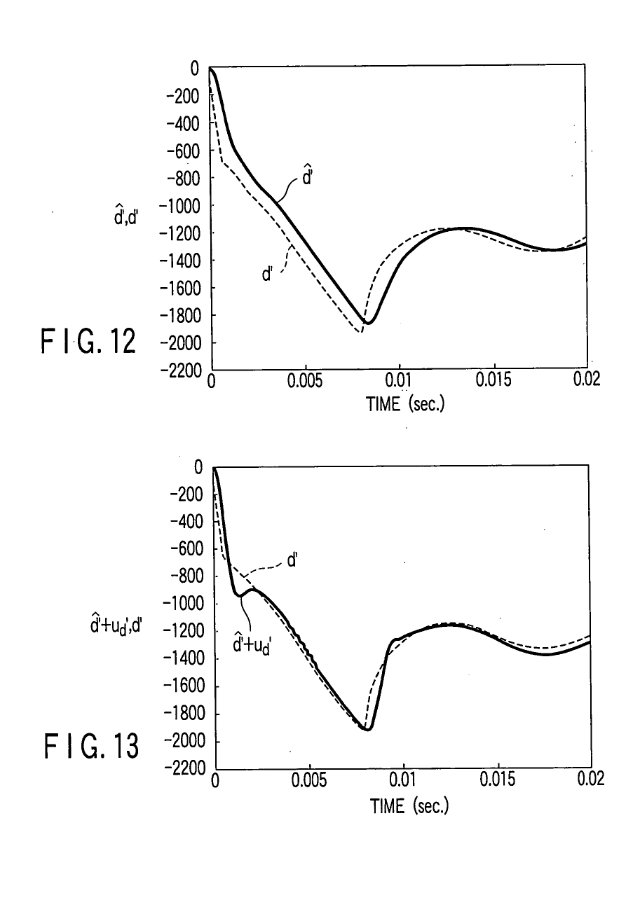

Further, the broken line and solid line in FIG. 12 indicate changes with time in the level of the disturbance d′ (Bd′=external disturbance Bd+modeling error [Aₘ−A]x) actually applied to the controlled object 2, and in the level of the disturbance estimate \hat{d}′ acquired by the disturbance observer 11, respectively. Similarly, the broken line and solid line in FIG. 13 indicate changes with time in the level of the disturbance d′ actually applied to the controlled object 2, and in the level of the sum (actual disturbance estimate \hat{d}′+u_{d}′) of the disturbance estimate \hat{d}′ acquired by the disturbance observer 11 and the disturbance estimate u_{d}′ acquired by the reference model tracking controller 15, respectively.

As is evident from the characteristic shown in FIG. 12, the disturbance observer 11 estimates disturbance values in slight retard of the actual disturbance values, because of the influence of the cutoff frequency of the observer 11. In other words, the disturbance observer 11 does not perform accurate disturbance estimation. If the disturbance estimate acquired by the disturbance observer 11 is fed back as the control input to the controlled object 2, disturbance cannot completely be eliminated, with the result that the state of the reference model 121 cannot accurately be tracked. To avoid this, the sliding mode controller 151 estimates, as shown in FIG. 11, the errors occurring in the disturbance observer 11 during disturbance estimation, and corrects the disturbance estimates as indicated by the solid line of FIG. 13.

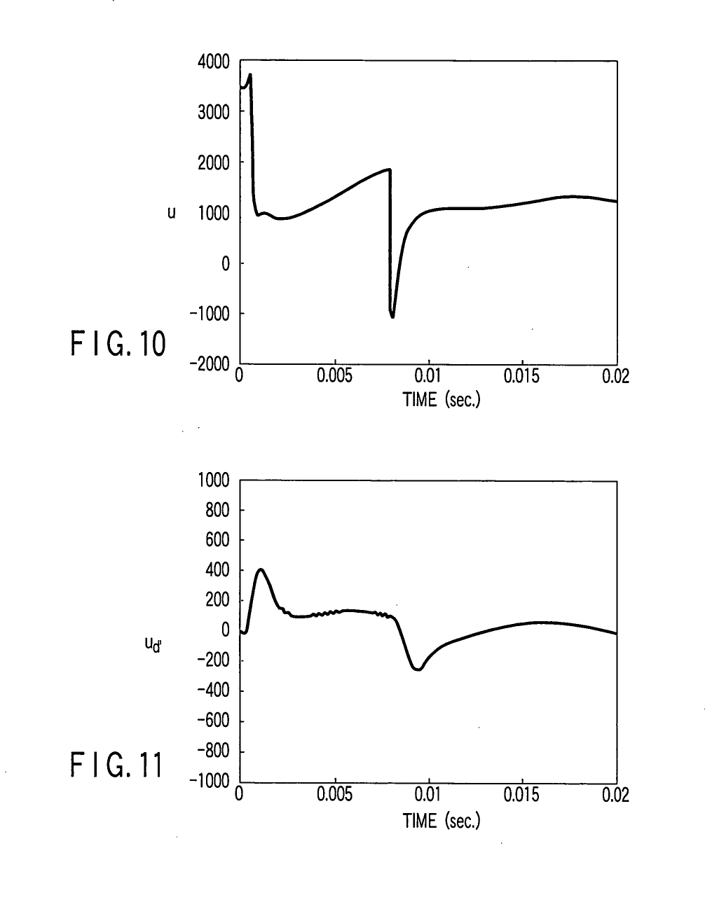

In the above simulation, the sliding mode controller 151 utilizes the acceleration reaching rule instead of a relay function, to determine the nonlinear input u_{d} for disturbance estimation. Therefore, the robustness near the switching plane is slightly reduced. Specifically, overshooting occurs at about 0.002 sec in the disturbance estimate (indicated by the solid line) with respect to the actual disturbance values (indicated by the broken line). After that, however, it can be understood that the reference model 121 is tracked with almost no delay, compared to the case of FIG. 12 where only the disturbance observer 11 is used. Further, chattering due to the sliding mode control system can be sufficiently prevented by the combination of the sliding mode controller 151 utilizing the acceleration arrival rule, and the lowpass filter 152. That is, no chattering occurs even in changes in the control input shown in FIG. 10 (changes in the current supplied to the voice coil motor). As aforementioned, the enhancement of the robustness and the reduction of chattering are in a tradeoff relationship. In the simulation, the sliding mode controller 151 was designed to utilize the acceleration reaching rule, putting emphasis on a reduction of chattering. However, if the sliding mode controller 151 utilizes a relay function, and it is allowable to take time and labor for designing the lowpass filter 152 and to slightly increase chattering, overshooting in disturbance estimate can be improved.

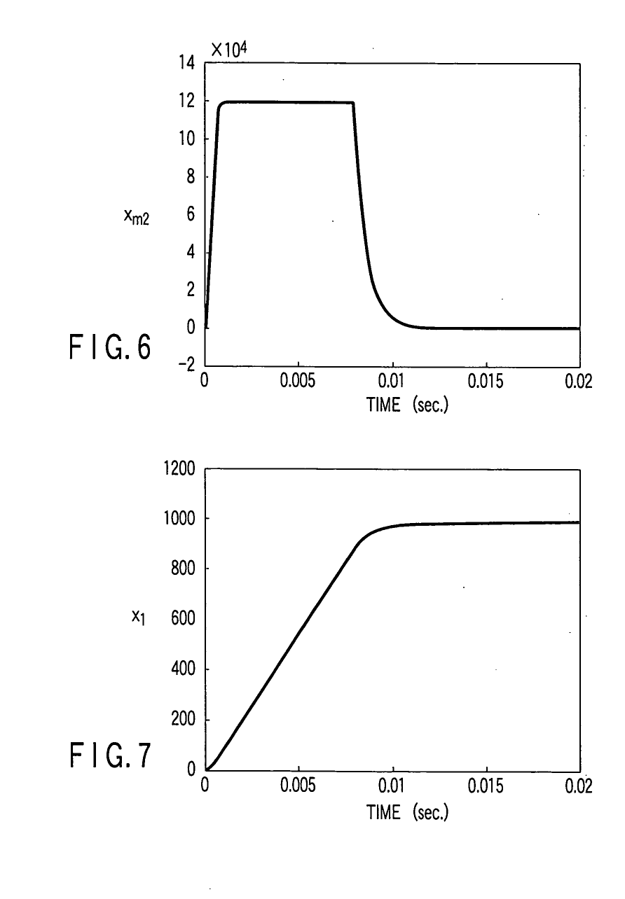

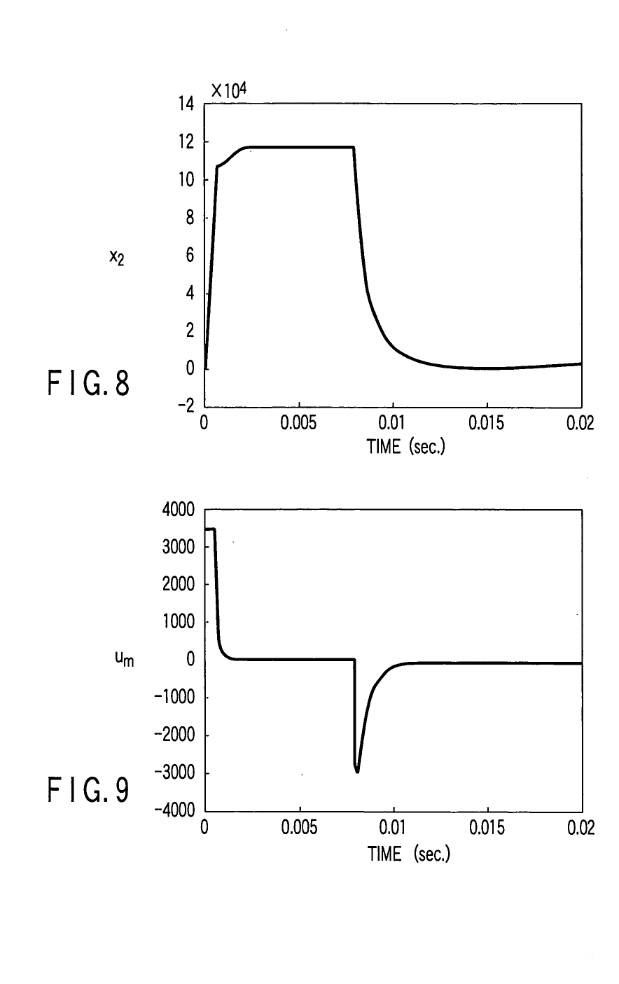

From the above-described results of simulation, it can be understood that as a result of accurate disturbance estimation, the position and velocity of the controlled object 2 shown in FIGS. 7 and 8 can very accurately track the position and velocity of the reference model 121 shown in FIGS. 5 and 6, regardless of the existence of disturbance. Thus, in the embodiment, a robust control system free from high-frequency chattering capable of more accurate disturbance estimation can be realized by combining the conventional disturbance observer with integral sliding mode control.

In the above embodiment, a reference model tracking control system used for a seek control system in a magnetic disk drive has been described. However, the present invention is not limited to this, but also applicable to a control system that contains unpredictable events such as disturbance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A reference model tracking control system for determining a control input supplied to a controlled object, based on an observed output of the controlled object and a reference value, a relationship between the control input of the controlled object and the observed output of the controlled object being modeled using a state equation, the reference value being a desired value of the observed output, comprising:
a disturbance observer configured to estimate a disturbance added to the control input, and an internal state variable of the controlled object at a predetermined sampling cycle, based on the control input and the observed output of the controlled object, the disturbance and the internal state variable estimated by the disturbance observer being output as a disturbance estimate and a state variable estimate, respectively;
a reference model as a simplified ideal model of the controlled object, the reference model being configured to cause a reference output corresponding to the observed output of the controlled object to track the reference value, and the reference model outputting, as a reference state variable, an internal state variable of the reference model acquired during tracking of the reference value;
an error calculator configured to calculate an error in the state variable estimate and the observed output of the controlled object with respect to the reference state variable;
a linear controller configured to generate a linear control input for converging the error calculated by the error calculator; and
a reference model tracking controller configured to generate another control input supplied to the controlled object at a next sampling cycle, based on the linear control input, the disturbance estimate and a nonlinear control input, the nonlinear control input being an error in the disturbance estimate with respect to a disturbance actually added to the control input at a present sampling cycle.

2. The reference model tracking control system according to claim 1, wherein the reference model tracking controller includes a calculator configured to subtract the disturbance estimate and the nonlinear control input from the linear control input, and to generate the subtraction result as the control input of the controlled object at the next sampling cycle.

3. The reference model tracking control system according to claim 1, wherein the reference model tracking controller includes a sliding mode controller for reference model tracking, the sliding mode controller being configured to estimate the error in the disturbance estimate from the error calculated by the error calculator, the control input of the controlled object at the present sampling cycle, and the disturbance estimate, and to generate the estimated error as the nonlinear control input.

4. The reference model tracking control system according to claim 3, wherein the sliding mode controller for reference model tracking utilizes integral dynamics for a switching plane.

5. The reference model tracking control system according to claim 3, wherein:
the reference model tracking controller includes a lowpass filter configured to eliminate a high-frequency component from the nonlinear control input generated by the sliding mode controller for reference model tracking; and
the reference model tracking controller uses a nonlinear control input generated by the lowpass filter to generate the control input supplied to the controlled object at the next sampling cycle.

6. The reference model tracking control system according to claim 1, further comprising:
a desired value determination unit configured to determine a desired value corresponding to an error in the reference output with respect to the reference value and also corresponding to the reference state variable; and
a sliding mode controller for reference model tracking configured to generate a nonlinear control input to be supplied to the reference model, using, as a switching function, an error in the reference state variable with respect to the desired value determined by the desired value determination unit, the nonlinear control input making zero the error in the reference state variable.

7. The reference model tracking control system according to claim 6, wherein:
the reference output, the reference value, the reference state variable and the desired value indicate a position, a desired position, a velocity and a desired velocity of the reference model, respectively; and
the desired value determination unit includes a velocity table which holds desired velocity values corresponding to respective preset head position errors, the desired value determination unit determining a desired value indicating the desired velocity of the reference model, in accordance with an error in the position of the reference model, indicated by the reference output, with respect to the desired position of the reference model indicated by the reference value.

8. A method of causing an internal state variable of a controlled object to track a reference state variable, a relationship between a control input of the controlled object and an observed output of the controlled object being modeled using a state equation, the reference state variable being an internal state variable of a reference model as a simplified ideal model of the controlled object, the method comprising:
estimating a disturbance added to the control input, and the internal state variable of the controlled object at a predetermined sampling cycle, based on the control input and the observed output of the controlled object, the estimating the internal state variable including outputting the estimated disturbance and the estimated internal state variable as a disturbance estimate and a state variable estimate, respectively;
causing a reference output of the reference model to track a reference value, the reference output corresponding to the observed output of the controlled object, the reference value being a desired value of the observed output of the controlled object;
outputting the reference state variable of the reference model used to make the reference output to track the reference value;
calculating an error in the state variable estimate and the observed output of the controlled object with respect to the reference state variable;
generating a linear control input for converging the error calculated by the error calculator;
estimating an error in the disturbance estimate with respect to a disturbance actually added to the control input of the controlled object at a present sampling cycle, based on the error in the state variable estimate and the observed output of the controlled object with respect to the reference state variable, the control input at the present sampling cycle and the disturbance estimate, the estimating the error in the disturbance estimate including outputting the estimated error as a nonlinear control input; and
generating another control input supplied to the controlled object at a next sampling cycle, based on the linear control input, the disturbance estimate and the nonlinear control input.

9. The method according to claim 8, wherein the generating the control input includes subtracting the disturbance estimate and the nonlinear control input from the linear control input.

10. The method according to claim 8, wherein the sliding mode control is executed for estimating the error in the disturbance estimate, and integral dynamics is used for a switching plane.

11. The method according to claim 8, further comprising eliminating, using a lowpass filter, a high-frequency component from the nonlinear control input, the high-frequency component being output when the error in the disturbance estimate is estimated,
and wherein the generating the control input uses, for generation of the control input, the nonlinear control input whose high-frequency component has been eliminated by the lowpass filter.

12. The method according to claim 8, further comprising:
determining a desired value corresponding to the error in the reference output with respect to the reference value, and also corresponding to the reference state variable; and
generating a nonlinear control input to be supplied to the reference model, using, as a switching function, an error in the reference state variable with respect to the determined desired value, the generated nonlinear control input making zero the error in the reference state variable.

13. The method according to claim 12, wherein:
the reference output, the reference value, the reference state variable and the desired value indicate a position, a desired position, a velocity and a desired velocity of the reference model, respectively; and
the desired value is determined, referring to a velocity table, in accordance with an error in the position of the reference model, indicated by the reference output, with respect to the desired position of the reference model indicated by the reference value.
